(19) United States
(12) Patent Application Publication
(10) Pub. No.: US 2015/0022041 A1
(43) Pub. Date: Jan. 22, 2015

(54) METHOD OF COOLING A GENERATOR OR MOTOR ROTOR WITH END DISKS AND A HYBRID SHAFT ASSEMBLY

(71) Applicant: HONEYWELL INTERNATIONAL INC., MORRISTOWN, NJ (US)

(72) Inventors: Steven Robert Eccles, Torrance, CA (US); Carol A. Oximberg, Los Angeles, CA (US); Stephen L. White, Whittier, CA (US); David G. Elpern, Los Angeles, CA (US); Wayne Schindler, Huntington Beach, CA (US)

(73) Assignee: HONEYWELL INTERNATIONAL INC., MORRISTOWN, NJ (US)

(21) Appl. No.: 14/196,959

(22) Filed: Mar. 4, 2014

Related U.S. Application Data
(60) Provisional application No. 61/847,917, filed on Jul. 18, 2013.

(51) Int. Cl. H02K 9/22

(52) U.S. Cl. CPC H02K 9/22
USPC 310/156.01

(57) ABSTRACT

A shaft assembly includes a shaft with magnets surrounding the shaft, and thermal conducting disks coupled to the shaft, and coupled to two ends of the magnets.

### BACKGROUND OF THE INVENTION

The present invention generally relates to cooling a generator or motor rotor. As a generator rotates, heat may develop in a region of the rotor's magnets and aluminum fillers between the magnets. There may be a need to maintain an acceptable temperature level in the magnets to avoid overheating them and causing damage or performance degradation.

As can be seen, there is a need for a generator or motor rotor with end disks and a hybrid shaft assembly, to enhance the thermal conduction.

### SUMMARY

In one aspect of the invention, a shaft assembly comprises a shaft; a plurality of magnets surrounding the shaft; and a pair of thermally conductive disks attached to opposite ends of each of the plurality of magnets, and in contact with the shaft.

In another aspect of the invention, a shaft assembly comprises a shaft; a plurality of magnets surrounding the shaft; a thermally conductive filler material attached to the plurality of magnets and positioned between the plurality of magnets; and a pair of thermally conducting disks coupled to the shaft, and attached to both ends of each of the plurality of magnets.

In another aspect of the invention, a shaft assembly comprises a thermally conductive shaft; a plurality of magnets surrounding the thermally conductive shaft; and a pair of thermally conductive disks attached on two ends of each of the plurality of magnets.

These and other features, aspects and advantages of the present invention will become better understood with reference to the following drawings, description and claims.

### BRIEF DESCRIPTION OF THE DRAWINGS

FIG. 1 is a side cross-section view of a shaft assembly according to an exemplary embodiment of the invention;

FIG. 2 is a side cross-section view of the shaft assembly of FIG. 1, including a thermally conductive liner;

FIG. 3 illustrates a top cross-section view of the shaft assembly of FIG. 1 along line A-A;

FIG. 4 illustrates a side cross-section view of the shaft assembly of FIG. 1 showing one side of the shaft assembly; and

FIG. 5 is a top cross-section view of the shaft assembly of FIG. 4 along line B-B.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, an embodiment of the present invention generally provides a heat transfer system.

More specifically, the present invention may utilize material of low thermal resistance in disks connected to magnets in a motor to transfer heat away from the magnets. In some embodiments, the heat from the disks may be in connection with the motor shaft providing a thermal pathway from the magnets to the shaft.

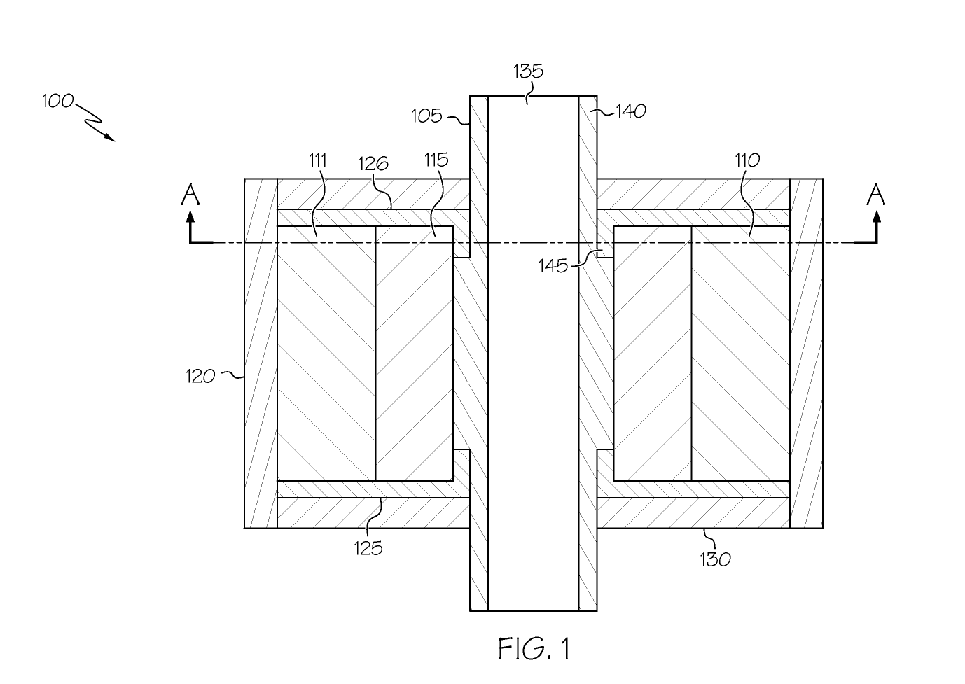

FIG. 1 shows a shaft assembly 100, that may include a shaft 105, magnets 110 and 111, and heat sinks 125, 126. For example, the heat sinks 125, 126 may be thermally conductive disks positioned on two ends of the magnets 110, 111. The heat sinks 125, 126 may route excess heat from the magnets 110, 111 to the shaft 105. In an embodiment, the heat sinks 125, 126 may completely encircle the shaft 105. In an embodiment, non-magnetic end disks 130 may be coupled to the heat sinks 125, 126. In an embodiment, the heat sinks 125, 126 may also be positioned at two ends of a non-thermally conductive layer 115. The non-thermally conductive layer 115 may surround the shaft 105. In an embodiment, a non-magnetic sleeve 120 may surround the magnets 110, 111. In an embodiment, the disks 125, 126 may be made of aluminum, aluminum alloy, or another thermally conductive material. In an exemplary embodiment, the shaft assembly 100 may include four magnets, or additional magnets in multiples of two. In an embodiment, the shaft assembly 100 may include a hollow core center 135, a first layer 140, and a second layer 145.

In an embodiment, the first layer 140 may be made of non-thermally conductive material such as steel, and the second layer 145 may be made of thermally conductive material, such as aluminum. In another embodiment, the shaft 105 may be surrounded by a thermally conductive first layer 140, and the second layer 145, may be non-thermally conductive. The first layer 140 may be non-magnetic. The magnets 110, 111 may surround the shaft 105. In an embodiment, the non-thermally conductive layer 115 may be made of steel. In an embodiment, the heat sinks 125, and 126 may be in contact with the shaft 105. The non-thermally conductive layer 115 may be positioned between the magnets 110, 111 and the shaft 105 such that the non-thermally conductive layer is surrounded by the magnets 110, 111. The non-thermally conductive layer 115 may be coupled to the heat sinks 125, 126. In an embodiment, the shaft 105 is non-magnetic. In a further embodiment, the shaft 105 is thermally conductive.

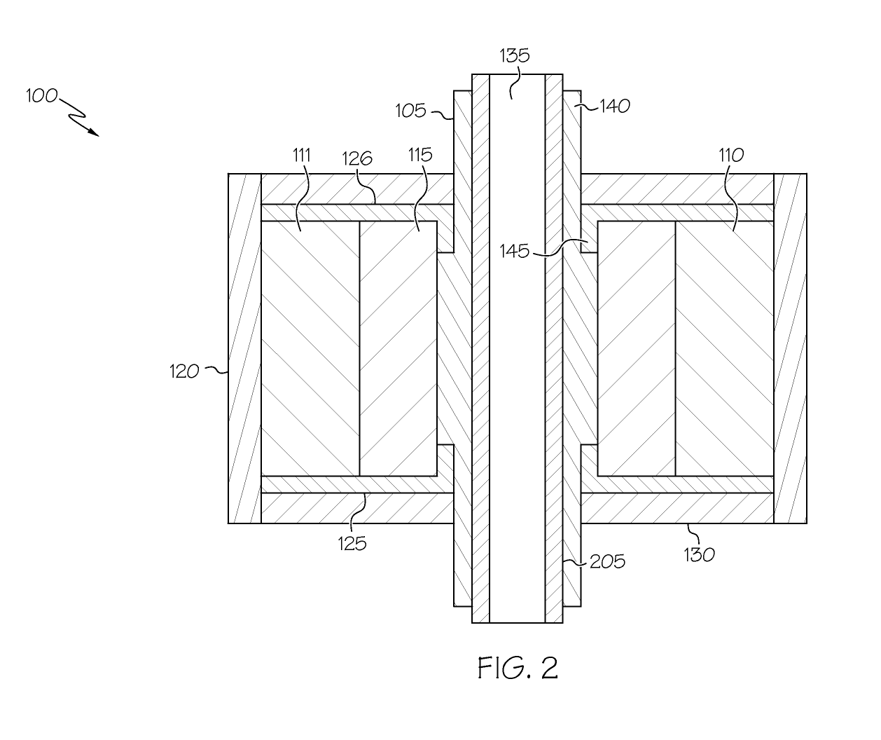

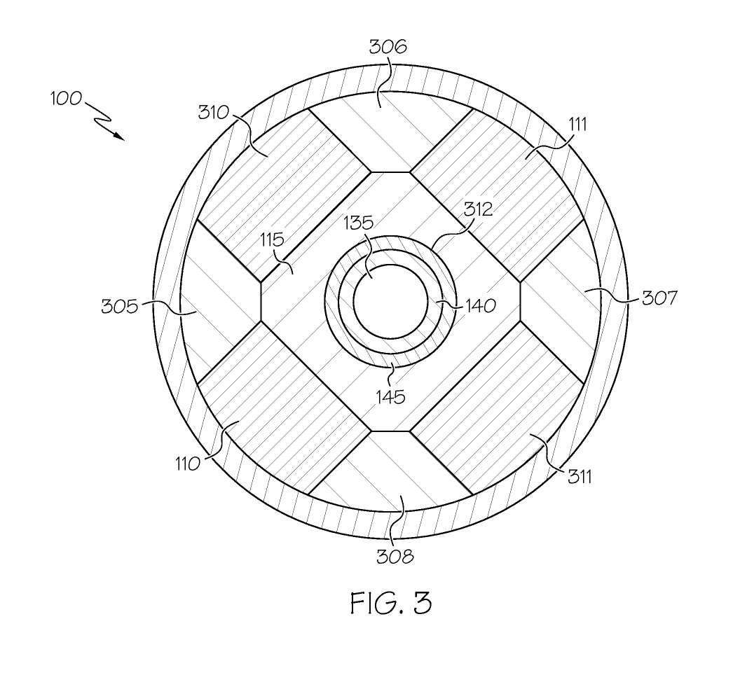

FIG. 2 shows the shaft assembly of FIG. 1, with a thermally conductive liner 205. The thermally conductive liner may route excess heat from the magnets 110, 111, after the excess heat passes through the thermally conductive heat sinks 125, 126 to the shaft 105. In an embodiment, the shaft assembly 100 may perform heat management in a permanent magnet rotor for either a motor or a generator. As the motor or generator rotates, heat may develop in the magnets 110, 111. Excess heat may build up in the magnets 110, 111, in the sleeve 120, and in fillers (See FIG. 3) due to inefficiencies caused by rotating electrical and magnetic fields. Material of low thermal resistance such as aluminum may be added to the heat sinks 125, 126 in intimate contact with the magnets. Heat may be directed away from the magnets 110, 111 through the heat sinks 125, 126, to the shaft 105 because of the lower temperature of the heat sinks 125, 126 and the shaft 105 than the magnets 110, 111. In an embodiment, the heat sinks 125, 126 may be made of copper, aluminum, or other thermally conductive material.

FIG. 3 illustrates a top cross-section view of the shaft assembly 100 of FIG. 1 along line A-A. In an exemplary embodiment, the shaft assembly 100 may include a shaft core 312 with a hollow middle 135, the first layer 140, and the second layer 145. The shaft assembly 100 may include thermally conductive fillers 305, 306, 307, and 308. The fillers 305, 306, 307, 308 may also draw heat away from the magnets 110, 111, 310, and 311. The fillers 305, 306, 307, and 308 may be positioned between, and coupled with, the magnets 110, 111, 310, 311. The fillers 305, 306, 307, 308 may be in contact with the disks (FIG. 1, 125, 126) and also in contact with the non-thermally conductive layer 115. The fillers 305, 306, 307, 308 may be made of non-magnetic material.

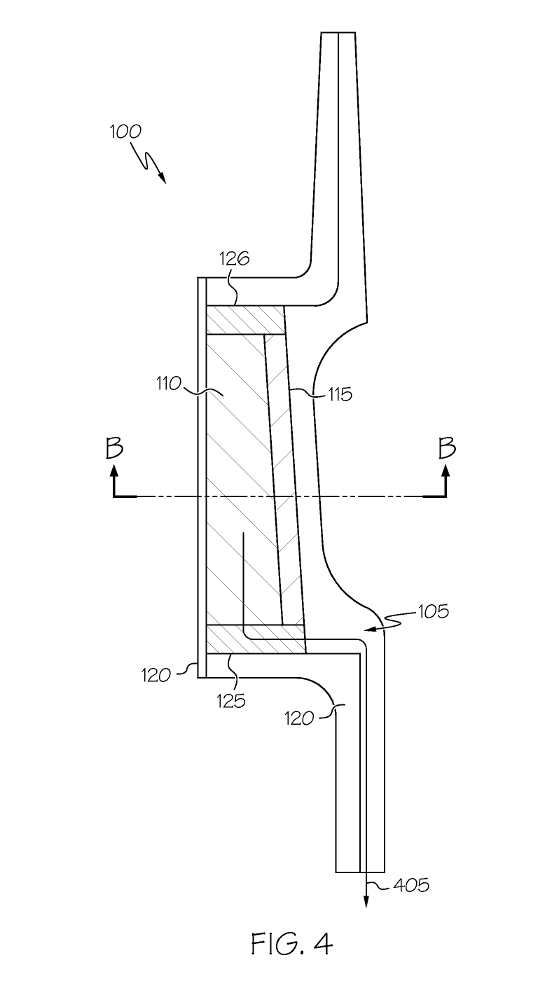

FIG. 4 illustrates a side cross-section view of the shaft assembly 100 of FIG. 1. FIG. 4 only shows one side of the shaft assembly 100 from FIG. 1. Thermally conductive disks 125, 126 may be on two sides of the magnet 110. Heat may transfer from the magnet 110 to the thermally conductive shaft 105 through the disks 125,126 (See flow arrow 405). Heat may also transfer from the magnet 110 directly through the sleeve 120 to the shaft 105. Having a thermally conductive shaft 105 will decrease thermal resistance down the length of the shaft 105 and may draw heat away from the magnet 110. The sleeve 120 may be non-magnetic and may encase the shaft assembly 100. The disks 125,126 may be in contact with the magnet 110. The disks 125,126 may also directly contact the shaft 105. In an embodiment, the shaft 105 and the disks 125,126 may be a single, integral piece. In an exemplary embodiment, the shaft 105 may be made of other materials or compounds with thermally conductive properties such as aluminum or copper.

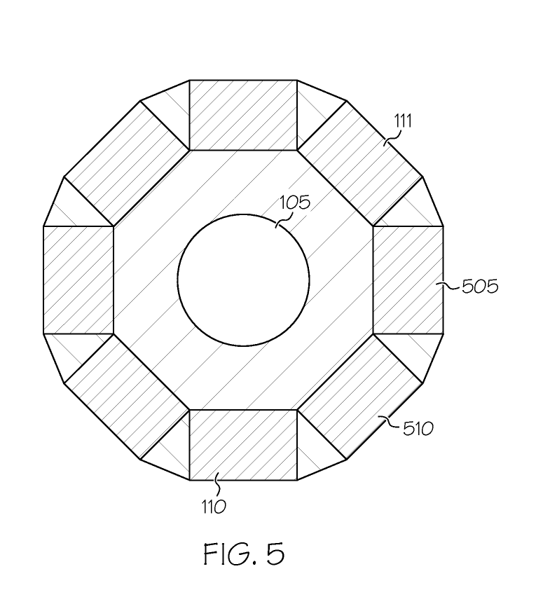

FIG. 5 is a top view of the shaft assembly 100 of FIG. 4 along line B-B. Shown is the shaft 105 and surrounding magnets 110, 111. FIG. 5 is shown with additional magnets 505 and 510, and additional magnets that are not shown may completely encircle the shaft 105. FIG. 5 is only a skeletal view with only the magnets and shaft shown to show an embodiment with additional magnets 505, 510 in a configuration with more magnets than FIG. 3.

It should be understood, of course, that the foregoing relates to exemplary embodiments of the invention and that modifications may be made without departing from the spirit and scope of the invention as set forth in the following claims.

We claim:

1. A shaft assembly, comprising:
a shaft;
a plurality of magnets surrounding the shaft; and
a pair of thermally conductive disks attached to opposite ends of the plurality of magnets.

2. The shaft assembly of claim 1, wherein a non-magnetic material is positioned between the plurality of magnets and the shaft.

3. The shaft assembly of claim 1, wherein a non-magnetic material is coupled to the pair of thermal conducting disks and is coupled to the shaft and to the plurality of magnets.

4. The shaft assembly of claim 1,
wherein the shaft is made of a non-magnetic material.

5. The shaft assembly of claim 1,
wherein the shaft is surrounded by a non-thermally conductive material.

6. The shaft assembly of claim 1, wherein the non-thermally conductive material is surrounded by the plurality of magnets.

7. The shaft assembly of claim 1, wherein a thermally conductive filler material is positioned between the plurality of magnets.

8. A shaft assembly, comprising:
a shaft;
a plurality of magnets surrounding the shaft;
a thermally conductive filler material attached to the plurality of magnets and positioned between the plurality of magnets; and
a pair of thermally conducting disks attached to respective ends of the plurality of magnets.

9. The shaft assembly of claim 8,
wherein the shaft is surrounded by a thermally conductive layer.

10. The shaft assembly of claim 8, wherein the shaft is surrounded by a thermally conductive layer, and a non-thermally conductive layer surrounds the thermally conductive layer.

11. The shaft assembly of claim 10, wherein the plurality of magnets surround the non-thermally conductive layer.

12. A shaft assembly, comprising:
a thermally conductive shaft;
a plurality of magnets surrounding the thermally conductive shaft; and
a pair of thermally conductive disks attached to respective ends of the plurality of magnets.

13. The shaft assembly of claim 12, wherein a non-magnetic, non-thermally conductive layer surrounds the thermally conductive shaft.

14. The shaft assembly of claim 12, wherein a non-magnetic and non-thermally conductive layer surrounds both the thermally conductive shaft and the plurality of magnets.

15. The shaft assembly of claim 12, wherein the thermally conductive disks are in contact with the thermally conductive shaft.

16. The shaft assembly of claim 12, wherein the thermally conductive disks are integrally part of the thermally conductive shaft.

17. The shaft assembly of claim 12, including a non-magnetic filler material positioned between the plurality of magnets.

18. The shaft assembly of claim 12, wherein the thermally conductive disks are in contact with the non-magnetic filler material.
